(19) United States
(12) Patent Application Publication
(10) Pub. No.: US 2007/0187571 A1
(43) Pub. Date: Aug. 16, 2007

(54) Autofocus control method, autofocus control apparatus and image processing apparatus

(76) Inventors: Hiroki Ebe, Miyagi (JP); Masaya Yamauchi, Miyagi (JP); Kiyoyuki Kikuchi, Miyagi (JP); Kiyotaka Kuroda, Tokyo (JP); Junichi Takahasi, Miyagi (JP)

Correspondence Address: William S Frommer;Frommer Lawrence & Haug, 745 Fifth Avenue, New York, NY, 10151, US

(21) Appl. No.: 10/569,480

(22) PCT Filed: Aug. 25, 2004
(86) PCT No.: PCT/JP04/12609

§ 371 Date: Oct. 20, 2006

(30) Foreign Application Priority Data
Aug. 26, 2003 (JP) 2003-301915
Jul. 20, 2004 (JP) 2004-212119

(51) Int. Cl. G02B 27/40

(52) U.S. Cl. 250/201.2

(57) ABSTRACT

An autofocus control method, an autofocus control apparatus and an image processing apparatus all of which can realize stable autofocus control operation by eliminating influences due to optical systems. In calculation of a focus evaluated value of each of sample images respectively acquired at a plurality of focused positions, each of the acquired sample image is subjected to smoothing to reduce a grayscale pattern of brightness due to an optical system, and the focus evaluated value is calculated on the basis of the smoothed sample image. In addition, the focus evaluated value is standardized with the screen average luminance of the sample image, thereby effecting optimization of the evaluated value.

### TECHNICAL FIELD

The present invention relates to, for example, an autofocus control method, an autofocus control apparatus and an image processing apparatus all of which are suitably used in equipment for image capture, observation and inspection of a subject sample through a video camera and are capable of realizing stable autofocus operation by eliminating the influences of optical systems in particular.

### BACKGROUND ART

Image autofocus control has heretofore been performed with focus evaluated values obtained by evaluating and quantifying the extent of focusing from image data of a subject sample (work). Namely, image data of a sample are collected at varied distances between a lens and a subject, and focus evaluated values are calculated as to the respective image data to search for a suitable focused position.

FIG. 21 shows the relationship between lens-to-work distances (the horizontal axis) and focus evaluated values (the vertical axis). This relationship is obtained by loading images while varying the lens-to-work distance at a constant interval, and calculating and plotting the focus evaluated values of the respective images. The maximum focus evaluated value in the graph is a focused position, i.e., an optimum focused position (focal position). The plots of the focus evaluated values against the lens-to-work distance will be hereinafter referred to as “focus curve(s)”.

In a conventional technique, it has been designed to vary the lens-to-work distance within a predetermined search range and determine a maximum value of focus evaluated values in the graph as an optimum focused position, or to calculate an optimum focused position from focus evaluated values before and after a maximum value. The focus evaluated values employ a maximum value of brightness, a derivative of brightness, dispersion of brightness, dispersion of derivative of brightness and the like. A hill-climbing method or the like is known as an algorithm for finding an optimum focused position from a maximum of focus evaluated values, and in addition, a method of dividing a search operation into a number of steps has been put to practical use for the purposes of a reduction in search time (Japanese Patent Application Laid-Open Nos. Hei 6-217180 and 2002-333571 and Japanese Patent Publication No. 2971892).

As miniaturization of target works proceeds, there is a greater demand toward a far more improvement in the resolution of inspection equipment to which such focus techniques are applied. An improvement in resolution can be realized by adopting a short-wavelength/single-wavelength illumination light source. Optical resolution can be increased by a short-wavelength construction, while the influence of chromatic aberration or the like can be avoided by a single-wavelength construction.

However, there is the problem that the kind of optical material such as a lens to be used in an optical path is limited by the short-wavelength construction of the illumination light source, and an influence such as a speckle occurs due to the single-wavelength construction. The speckle means a state in which the brightness of a screen is distributed in the form of spots, and assumes a unique pattern of grayscale distribution depending on the wavelength of a light source or the construction of an optical system.

Under these influences, there is a case where the focus curve is formed so that a section influenced by an optical system takes a larger value than the focus evaluated value at the optimum focused position, as shown in FIG. 22. The shape and the numerical range of a focus curve are not uniquely determined by a surface state, such as reflectivity, of an object. Accordingly, the conventional technique of finding a focused position from a maximum of focus evaluated values under the above-mentioned conditions cannot stably find an optimum focused position.

The present invention has been made in view of the above-mentioned problems, and an object of the present invention is to provide an autofocus control method, an autofocus control apparatus and an image processing apparatus all of which are capable of realizing stable autofocus operation by eliminating influences due to optical systems.

### DISCLOSURE OF THE INVENTION

To solve the above-mentioned problems, an autofocus control method according to the present invention includes an image acquiring step of acquiring respective image data of a subject at a plurality of focused positions differing from one another in lens-to-subject distance, an evaluated value calculating step of calculating a focus evaluated value for the plurality of focused positions on the basis of the respective acquired image data, a focal position calculating step of calculating a focused position where one of the focus evaluated values reaches a maximum, as a focal position, and a moving step of relatively moving a lens to the calculated focal position with respect to the subject. The autofocus control method performs smoothing on the acquired image data and calculates the focus evaluated values on the basis of the smoothed image data.

Namely, grayscale distribution of brightness is caused by a speckle due to a single wavelength. For this reason, in the present invention, image smoothing is added in order to reduce the grayscale distribution pattern. By this image smoothing, it is possible to grasp the feature of a target sample (subject) and optimally calculate focus evaluated values while reducing the grayscale distribution pattern of a speckle.

During the image smoothing, process conditions such as the number of pixels to be processed (a unit process range), a filtering coefficient, the number of times of processing and the presence or absence of weighting can be appropriately set according to the kind of optical system to which the process is to be applied, the surface properties of a subject sample, and the like.

In addition, during the calculation of the focus evaluated values, it is suitable to detect a difference in luminance data between neighboring pixels in acquired image data, and it is possible to employ, for example, edge enhancement which extracts a variation in luminance data between pixels of the feature and contour sections.

During the calculation of a focus evaluated value, if there is nonuniformity in luminance between focused positions in the same target area, the absolute value of a difference in luminance data between neighboring pixels varies, so that the focus evaluated value cannot be optimally calculated. For this reason, to avoid this problem, it is suitable to divide the calculated evaluated value by the average luminance of the entire screen and standardize the focus evaluated value with the screen average luminance.

In addition, it is possible to add the function of synthesizing an omnifocal image or a three-dimensional image of a subject from the focus evaluated values of respective sample images acquired at a plurality of focused positions, during the above-mentioned autofocus control operation. This process divides each of the images acquired at the respective focused positions into a plurality of areas in the screen, and is performed on the basis of a focus evaluated value and focused position information obtained for each of the divided areas. In this case, the surfaces of a subject having a three-dimensional structure can be inspected and observed with superior resolution with the influences of optical systems eliminated.

An autofocus control apparatus according to the present invention includes evaluated value calculating means which calculates respective focus evaluated values for the plurality of focused positions on the basis of respective acquired image data acquired at a plurality of focused positions differing from one another in lens-to-subject distance, focal position calculating means which calculates a focal position on the basis of a maximum of the calculated focus evaluated values, and image smoothing means which smoothes the acquired image data. The autofocus control apparatus calculates the focus evaluated values of the respective image data on the basis of the image data smoothed by the image smoothing means.

The autofocus control apparatus according to the present invention may be constructed as a single image processing apparatus by being combined with image acquiring means which acquires respective image data of a subject at a plurality of focused positions and driving means which adjusts the lens-to-subject distance, or can also be constructed as a separate structure independent from the image acquiring means and the driving means.

According to the present embodiment, since it is possible to stably perform highly accurate autofocus control by eliminating influences due to optical systems, it is possible to realize sample observation using a short-wavelength/single-wavelength optical system, so that it is possible to realize high-resolution observation of semiconductor wafers and the like microfabricated on a larger scale.

### BRIEF DESCRIPTION OF DRAWINGS

FIG. 1 is a schematic construction view of an image processing apparatus 1 according to a first embodiment of the present invention;

FIG. 2 is a block diagram for explaining the construction of a controller 7;

FIG. 3 is a flowchart for explaining the operation of the image processing apparatus 1;

FIG. 4 is a flowchart for explaining another operation example of the image processing apparatus 1;

FIG. 5 shows examples of focus curves for explaining one operation of the present invention, FC1 showing an example obtained when image smoothing and luminance standardization using focus evaluated values were performed, FC2 showing an example obtained when only image smoothing was performed, FC3 showing a conventional example;

FIG. 6 is a view for explaining a method of calculating a focal position by curve approximation in the neighborhood of a maximum of focus evaluated values;

FIG. 7 is a view showing the relationship between voltage directed to a lens driving section 4 and actual movement voltage of a lens;

FIG. 8 is a view for explaining a method of performing parallel processing of loading of a sample image and calculation of a focus evaluated value;

FIG. 9 is a view showing a second embodiment of the present invention and explaining a method of dividing a screen into a plurality of areas and detecting focal positions in the respective divided areas;

FIG. 10 is a process flowchart of a third embodiment of the present invention;

FIG. 11 is a memory construction diagram applied to the third embodiment of the present invention;

FIG. 12 is a flowchart for explaining an omnifocal image acquiring step;

FIG. 13 is a view showing a fourth embodiment of the present invention and explaining a method of acquiring a three-dimensional image by combining the focal positions of sample images in the focus-axis direction;

FIG. 14 is a flowchart for explaining a method of synthesizing the three-dimensional image;

FIG. 15 is a functional block diagram showing a first construction example of an autofocus control apparatus according to a fifth embodiment of the present invention;

FIG. 16 is a functional block diagram showing a second construction example of the autofocus control apparatus according to the fifth embodiment of the present invention;

FIG. 17 is a functional block diagram showing a third construction example of the autofocus control apparatus according to the fifth embodiment of the present invention;

FIG. 18 is a functional block diagram showing a fourth construction example of the autofocus control apparatus according to the fifth embodiment of the present invention;

FIG. 19 is a view showing a fifth construction example of the autofocus control apparatus according to the fifth embodiment of the present invention;

FIGS. 20A and 20B are block diagrams respectively showing modifications of the construction of a driving system of the image processing apparatus 1;

FIG. 21 shows one example of a focus curve showing the relationship between lens-to-work distances (focused positions) and focus evaluated values; and

FIG. 22 is a view for explaining a problem of a conventional technique.

### BEST MODE FOR CARRYING OUT THE INVENTION

Embodiments of the present invention will be described below with reference to the accompanying drawings.

### FIRST EMBODIMENT

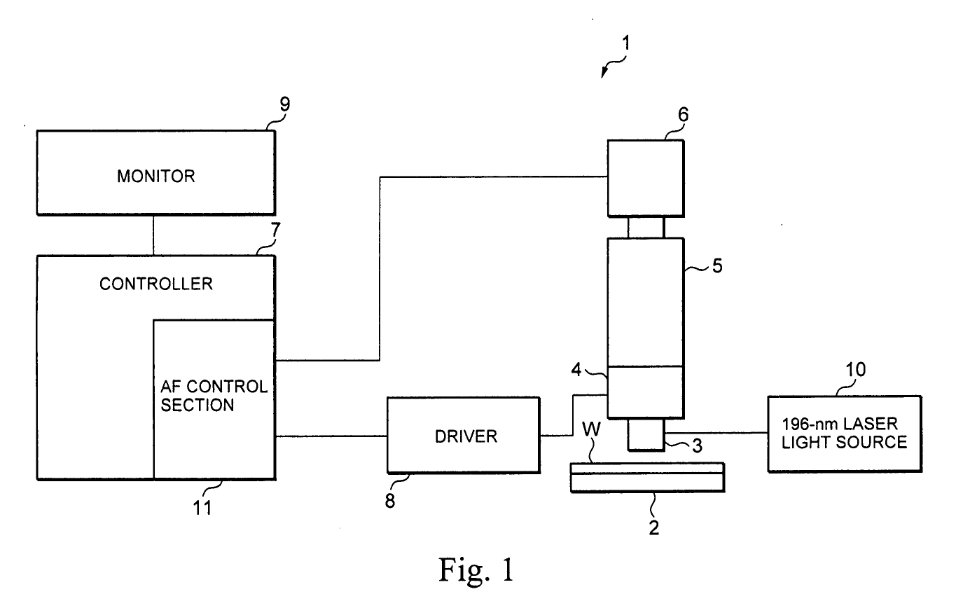

FIG. 1 is a schematic construction view of an image processing apparatus to which an autofocus control method and an autofocus control apparatus according to an embodiment of the present invention are applied. An image processing apparatus 1 is employed for surface observation of a subject sample (work), and is specifically constructed as a microscope to be employed for defect inspection of a device structure, such as a semiconductor wafer, which is constructed by micromachining being applied to its surface.

The image processing apparatus 1 is equipped with a measurement stage 2, an objective lens 3, a lens driving section 4, a lens barrel 5, a CCD (Charge Coupled Device) camera 6, a controller 7, a driver 8, a monitor 9 and an illumination light source 10.

The measurement stage 2 is constructed to support a subject sample (for example, a semiconductor wafer) W and move in the X-Y directions (in FIG. 1, in the right and left directions and in directions perpendicular to the sheet surface of the drawing).

The lens driving section 4 performs variable adjustment of a lens-to-work distance by relatively moving the objective lens 3 with respect to the subject sample W on the measurement stage 2 in the focus-axis direction (in the vertical direction in FIG. 1) within a predetermined focused position searching range. The lens driving section 4 corresponds to “driving means” in the present invention.

In the present embodiment, the lens driving section 4 is constructed with a piezoelectric device, but it is also possible to adopt other devices, for example, a precise feed mechanism such as a pulse motor. The objective lens 3 is adapted to be moved in the focus-axis direction for adjustment of the lens-to-work distance, but alternatively the measurement stage 2 may also be adapted to be moved in the focus-axis direction.

The CCD camera 6 functions as a video camera which captures an image of a particular area of a surface of the subject sample W on the measurement stage 2 through the objective lens 3 which moves within the focused position searching range, and outputs acquired image data to the controller 7. The CCD camera 6 constitutes “image acquiring means” in the present invention together with the objective lens 3, the lens driving section 4 and the lens barrel 5. In addition to a CCD, it is also possible to apply a solid-state image pickup device such as a CMOS imager.

The controller 7 is constructed with a computer, and controls the entire operation of the image processing apparatus 1 and is equipped with an autofocus (AF) control section 11 which detects an optimum focused position (focal position) on a particular area of a surface of the subject sample W. The autofocus (AF) control section 11 corresponds to an “autofocus control device” in the present invention.

The driver 8 receives control signals from the autofocus (AF) control section 11 and generates driving signals for driving the lens driving section 4. In the present embodiment, the driver 8 is constructed with a piezoelectric driver equipped with a hysteresis compensation function. The driver 8 may also be incorporated in the autofocus control section 11.

The autofocus control section 11 drives the lens driving section 4 through the driver 8, and acquires image data of the subject sample W through the CCD camera 6 at a plurality of focused positions obtained by varying the distance between the objective lens 3 and the subject sample W (the lens-to-work distance) at a constant interval and performs various processes, which will be described later, to detect an optimum focused position in an image capture area of the subject sample W, i.e., a focal position.

The monitor 9 displays the content of processing by the controller 7, and also displays an image and the like of the subject sample W captured by the CCD camera 6.

In the present embodiment, a continuous laser or a pulsed laser light source of wavelength 196 nm, for example, is employed as the illumination light source 10. The wavelength range of the illumination light source is not limited to the above-mentioned ultraviolet range, and as a matter of course, it is also possible to employ light sources having other different ultraviolet wavelength ranges or light sources having visible light ranges, according to uses and the like.

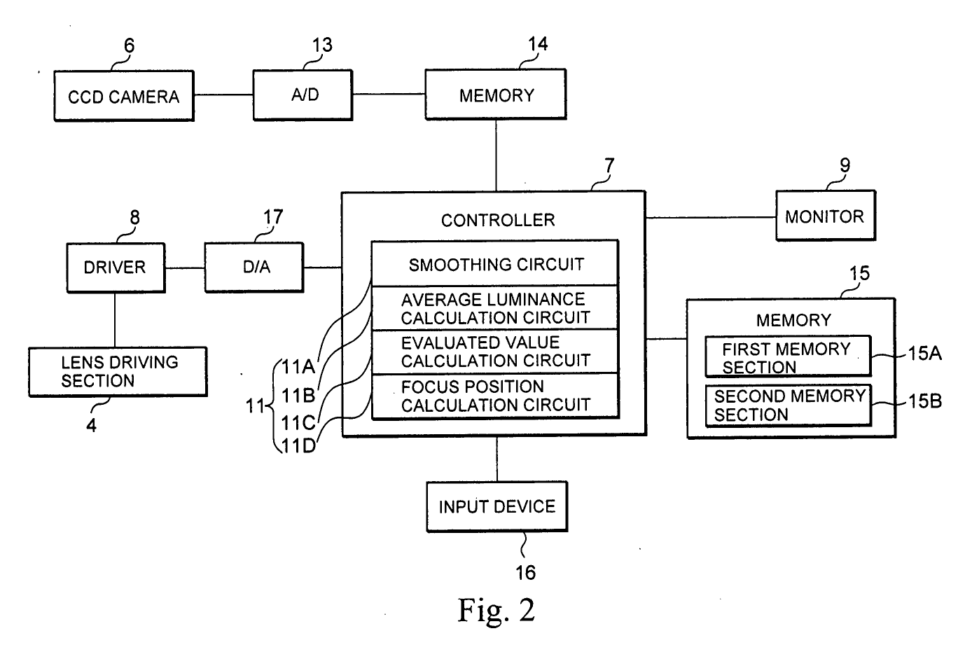

FIG. 2 is a block diagram of the construction of the image processing apparatus 1. An analog image signal outputted from the CCD camera 6 is converted to a digital image signal by an A/D converter 13. The output signal of the A/D converter 13 is supplied to and stored in a memory 14. The autofocus control section 11 of the controller 7 reads the converted digital image signal from the memory 14, and performs autofocus control which will be described later. Then, the driver 8 generates a driving signal for the lens driving section 4 on the basis of a control signal supplied from the controller 7 via a D/A converter 17.

The autofocus control section 11 is equipped with a smoothing circuit 11A, an average luminance calculation circuit 11B, an evaluated value calculation circuit 11C and a focal position calculation circuit 11D.

The smoothing circuit 11A is a circuit which performs smoothing of an autofocus target area (an entire screen or a partial area in the screen) of each of image signals (sample images) of the subject sample W which are respectively acquired at a plurality of focused positions, and corresponds to “image smoothing means” in the present invention. The autofocus control section 11 reduces the dotted distribution (speckle) of brightness of each sample image, acquired by the smoothing circuit 11A. An example of smoothing is shown in [Formula 1].

$$( \begin{matrix}1 & 2 & 1 \\ 2 & 4 & 2 \\ 1 & 2 & 1\end{matrix} ) / 16 \qquad [ Formula 1 ]$$

In addition, a process condition for image smoothing (the number of pixels to be processed (in the above example, 3×3), a filtering coefficient, the number of times of processing, the presence or absence of weighting, how to select a weighting coefficient, and the like) can be arbitrarily set within a range which does not allow loss of the original details of the feature or contour section of the surface of the subject W captured by the CCD camera 6. These process conditions may be set via an input device 16 such as a keyboard, a mouse or a touch panel.

The average luminance calculation circuit 11B is a circuit which calculates the screen average luminance of the autofocus target area of each sample image, and corresponds to “average luminance calculating means” in the present invention. The screen average luminance obtained at each focused position by the average luminance calculation circuit 11B is used for calculation of a focus evaluated value Pv at each focused position in an evaluated value calculation circuit 11C which will be described later.

The evaluated value calculation circuit 11C is a circuit which calculates the focus evaluated value Pv of each sample image, and corresponds to “evaluated value calculating means” in the present invention. In the present embodiment, the evaluated value calculation circuit 11C has a construction including an edge enhancement circuit.

In the present embodiment, the term “focus evaluated value” indicates an index representative of a numerical evaluation of the state in which the feature and contour sections of an image are clearly visible. As can be seen from a variation in luminance data between a pixel of the feature section and a pixel of the contour section, a clear image exhibits a sharp variation, while a blurred image exhibits a mild variation. For this reason, in the present embodiment, the focus evaluated value Pv is calculated by evaluating the difference in luminance data between neighboring pixels by the use of edge enhancement. Alternatively, the focus evaluated value may also be calculated on the basis of a derivative of brightness, dispersion of brightness, and the like.

In an actual process example, the operation shown in [Formula 2] is performed on all pixels of an acquired image, thereby finding the difference in luminance data between each pixel and the surrounding pixels. In this formula, the antecedent detects a luminance variation in the vertical direction, and the consequent detects a luminance variation in the horizontal direction. Accordingly, it is possible to extract only a luminance variation between an evaluation point and the surrounding ones, irrespective of the luminance of a pixel to be processed.

$$\{ \vert \begin{matrix}1 & 2 & 1 \\ 0 & 0 & 0 \\ - 1 & - 2 & - 1\end{matrix} \vert + \vert \begin{matrix}- 1 & 0 & 1 \\ - 2 & 0 & 2 \\ - 1 & 0 & 1\end{matrix} \vert \} \times \frac{1}{2} \qquad [ Formula 2 ]$$

In this example, a pixel area to be processed is 3×3, but may also be set to 5×5, 7×7 or the like. In addition, although the coefficient is weighted, the manner of setting of the coefficient is arbitrary, and processing may also be performed without weighting.

During the calculation of the focus evaluated value Pv, after the calculation of the above-mentioned edge enhancement formula, a division process is executed with the screen average luminance calculated at the corresponding focused position by the average luminance calculation circuit 11B. Specifically, the focus evaluated value Pv of each sample image is a value found by dividing a focus evaluated value Pvo obtained by the edge enhancement circuit by a screen average luminance Pave obtained at the corresponding focused position, as shown by [Formula 3].

$$Pv ( i ) = \frac{Pvo ( i )}{Pave ( i )} \qquad [ Formula 3 ]$$

In [Formula 3], Pv(i) is a focus evaluated value based on standardized luminance at the i-th focused position, Pvo(i) is a focus evaluated value at the i-th focused position, and Pave(i) is a screen average luminance at the i-th focused position.

In addition, as shown in [Formula 4], the focus evaluated value Pv may also be calculated by multiplying the calculated value obtained in [Formula 3] by a maximum value Pavemax of the screen average luminance. In this manner, a decrease (a quantitative decrease) in focus evaluated value due to division based on average luminance is compensated, so that a quantitative change in focus evaluated value can be easily viewed in later reference to a focus curve. In addition, the screen average luminance used for multiplication is not limited to the maximum value, and may also be a minimum value or the like.

$$Pv ( i ) = \frac{Pvo ( i )}{Pave ( i )} \times Pavemax \qquad [ Formula 4 ]$$

Accordingly, the reason why a value found by dividing an evaluated value calculated during edge enhancement by screen average luminance is employed as a focus evaluated value (Pv) is that the focus evaluated value is associated with how large the luminance difference between an evaluation point (pixel) and the surrounding pixels is, so that if there is nonuniformity in luminance between acquired images and there occurs a variation in the screen average luminance (a luminance value found by dividing the sum of the luminances of individual pixels constituting a screen by the total number of the pixels of the screen), it is necessary to avoid a variation in the absolute value of the resultant calculated index.

It is assumed that a luminance difference from the surrounding pixels is, for example, 20%. The luminance difference of 20% becomes 10 for an average luminance of 50, and 20 for an average luminance of 100. Accordingly, even in the case of the same variation rate, the absolute value greatly varies depending on the original screen average luminance. This problem hardly becomes serious in optical systems such as general visible microscopes, but the problem becomes remarkable in optical systems such as ultraviolet microscopes.

For this reason, in the present embodiment, to cope with such screen luminance variation, each focus evaluated value calculated during edge enhancement is standardized with screen average luminance (Pave) so that the influence of the screen luminance variation on the focus evaluated values can be prevented. Namely, values each obtained by dividing a focus evaluated value by the corresponding screen average luminance are employed as focus evaluated values, so that a focus evaluated value in the case of a screen average luminance of 50 and a luminance difference of 20% becomes 0.2 ( 10/50) and a focus evaluated value in the case of a screen average luminance of 100 and a luminance difference of 20% also becomes 0.2 ( 20/100), i.e., both focus evaluated values coincide with each other. Accordingly, the influence of variations in luminance between focused positions on the focus evaluated values can be eliminated.

The focal position calculation circuit 11D is a circuit which calculates a focused position on the basis of a maximum value of a focus evaluated value calculated in the evaluated value calculation circuit 11C, and corresponds to “focal position calculating means” in the present invention.

In general, image autofocus control determines a focused position by acquiring sample images at a plurality of focused positions differing from one another in lens-to-work distance and detecting a focused position of a sample image at which a maximum focus evaluated value is obtained. Accordingly, the larger the number of sample images (the smaller the amount of focus movement between samples), the more accurate the autofocus control can be. However, on the other hand, an increase in the number of samples leads to an increase in the time required for processing, so that the high-speed performance of the autofocus control becomes difficult to ensure.

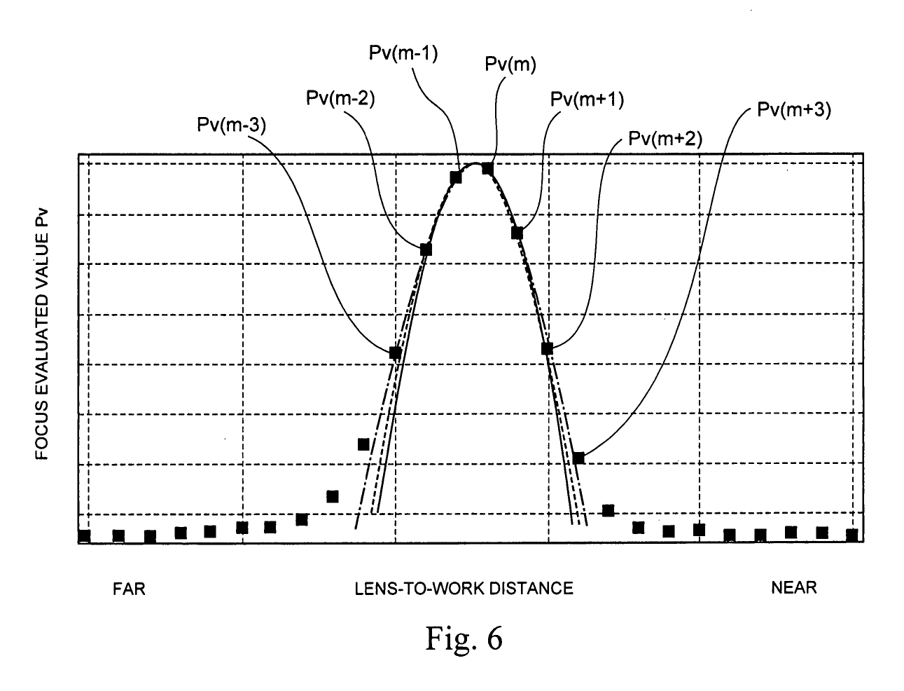

For this reason, in the present embodiment, as shown in FIG. 6, an optimum focused position (focal position) is detected on the basis of a maximum value Pv(m) of calculated focus evaluated values and a plurality of neighboring focus evaluated values (Pv(m−1), Pv(m+1), Pv(m−2), Pv(m+2), Pv(m−3) and Pv(m+3)).

As shown in FIG. 6, the focal-position neighborhood approximates a quadratic curve which is upwardly convex. Accordingly, the focal-position neighborhood points are used to calculate an approximate quadratic curve by the method of least squares, thereby finding an apex as a focal position. In FIG. 6, a solid line is a curve approximately calculated from three points (Pv(m), Pv(m−1) and Pv(m+1)), a dashed line is a curve approximately calculated from five points (Pv(m), Pv(m−1), Pv(m+1), Pv(m−2) and Pv(m+2)), and a dot-dashed line is a curve approximately calculated from seven points (Pv(m), Pv(m−1), Pv(m+1), Pv(m−2), Pv(m+2), Pv(m−3) and Pv(m+3)). From the fact that the graphs are open to different extents but the positions of the respective apexes are approximately the same, it can be seen that the method shown in FIG. 6 is an approximation method which is effective in spite of being a simple process.

The above-mentioned curve approximation method is not limitative, and a focal position may also be detected by a method (collinear approximation method) of finding a focal position by calculating the point of intersection of, for example, a straight line passing through two points Pv(m) and Pv(m+1) with the line and a straight line passing through another two points Pv(m−1) and Pv(m−2), or other approximation methods such as normal distribution curve approximation.

Referring back to FIG. 2, the memory 15 is employed for various operations in a CPU of the controller 7. Specifically, the memory space of the memory 15 is allocated to a first memory section 15A and a second memory section 15B to be used for various operations in the autofocus control section 11.

In the present embodiment, to ensure the high-speed performance of the autofocus control, sample images are respectively acquired at a plurality of focused positions while the lens-to-work distance is being continuously varied. Accordingly, it is possible to increase the speed of the autofocus control compared to the case where when a lens is stopped at each focused position, an image is acquired.

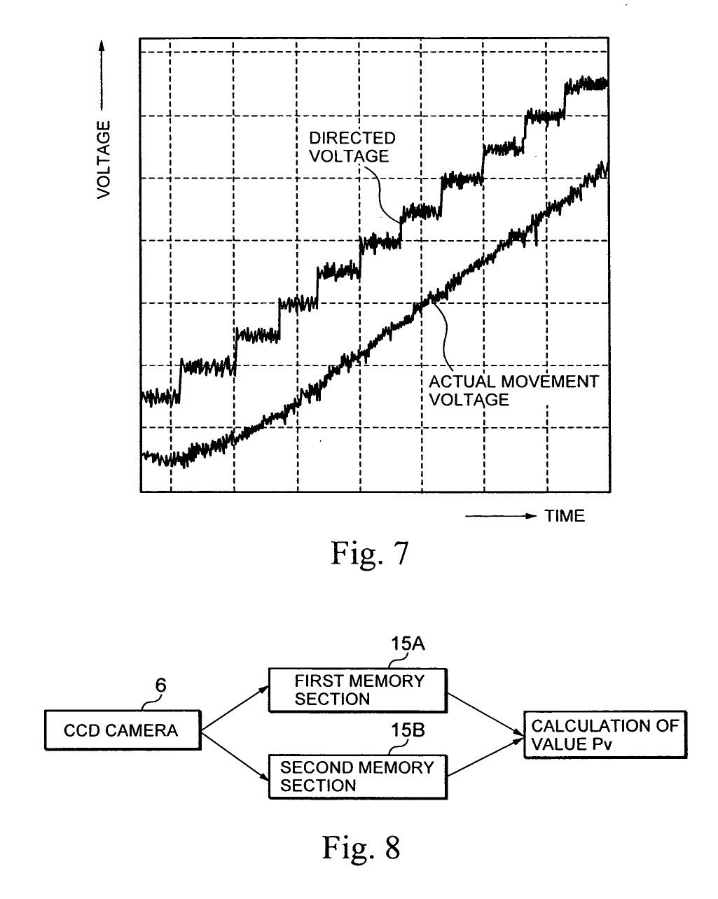

FIG. 7 shows the relationship between voltage directed to the lens driving section 4 by the driver 8 and actual movement voltage of the lens driving section 4. The lens driving section 4 made of a piezoelectric device is equipped with a movement-amount detection sensor for position control. The actual movement voltage shown in FIG. 7 is a monitor signal of this sensor. The directed voltage is varied by a predetermined amount at a period of one video signal frame of the CCD camera 6 after the lens has been moved to an autofocus control start position. A comparison of the directed voltage and the actual movement voltage shows that although a delay in response is observed, the movement of the lens is smooth and the inclinations of both graphs are approximately the same in a gradually increasing range with the steps of the directed voltage flattened. From this fact, it can be seen that the lens operates at an equal speed with respect to the directed voltage corresponding to the equal speed. Accordingly, if sample images are acquired in synchronism with image synchronizing signals, it is possible to calculate and acquire focus evaluated values at a constant interval on the focus-axis coordinates.

Furthermore, in the present embodiment, a sample image acquisition process and a focus evaluated value calculation process are performed in parallel in order to increase the speed of autofocus operation.

These processes can be constructed by the double buffering of processing image data previously loaded in the second memory section 15B and calculating the focus evaluated value Pv, while loading image data into the second memory section 15A. In the case of the present example, image data loaded during each even frame is processed in the second memory section 15A, while image data loaded during each odd frame is processed in the second memory section 15B.

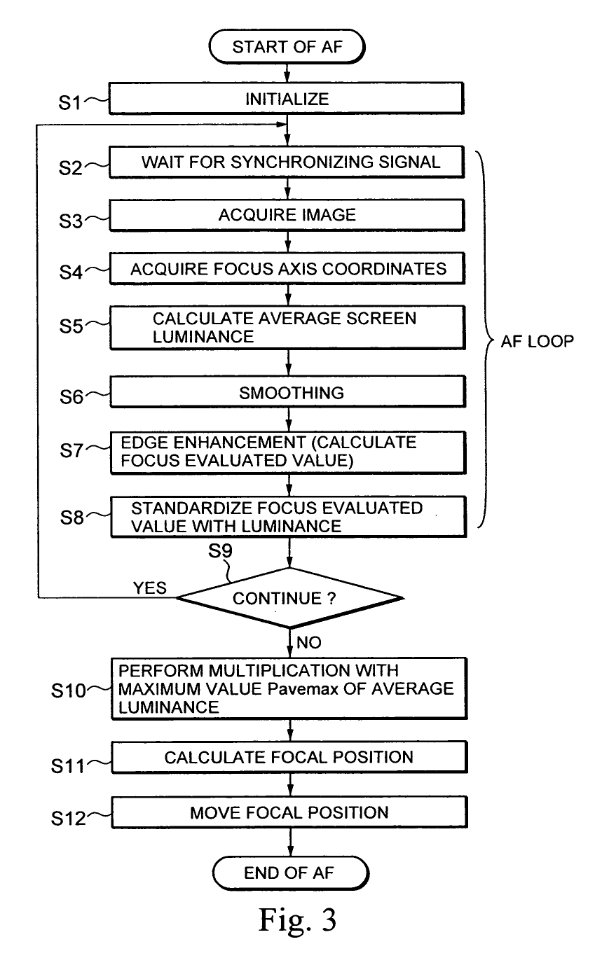

The operation of the image processing apparatus 1 according to the present embodiment constructed in the above-mentioned manner will be described below with reference to FIG. 3. FIG. 3 is a process flowchart of the autofocus control section 11.

First, initial settings are inputted such as an autofocus process area of the subject sample W, a focused position searching range of the same, the amount of focus movement between image samples to be acquired (a focus-axis step length), an image smoothing condition, and an edge enhancement condition (step S1), and then, autofocus control is executed.

The objective lens 3 starts moving from an autofocus control start position along the focus-axis direction (in the present embodiment, a direction toward the subject sample W) by being driven by the lens driving section 4, and also acquires a sample image of the subject sample W in synchronism with an image synchronizing signal (steps S2 and S3). Then, the focus-axis coordinates of the acquired sample image (lens-to-work distance coordinates) are acquired (step S4).

After that, a focus evaluation process which is made of screen average luminance calculation, image smoothing, edge enhancement and luminance standardization for the acquired sample image is performed (steps S5 to S8).

The screen average luminance calculating step (step S5) is computed by the average luminance calculation circuit 11B. A calculated screen average luminance is used in a calculation of a focus evaluated value in a later step. The screen average luminance calculating step may also be performed after the smoothing step (step S6).

The image smoothing step (step S6) is processed in the smoothing circuit 11A. In the image smoothing step, image smoothing is performed with, for example, the operating formula shown in [Formula 1]. In this step, the influence of speckles due to the single-wavelength mode of the light source is eliminated from the acquired sample image.

The edge enhancement step (step S7) is executed by the evaluated value calculation circuit 11C. In this step, a difference in luminance data between pixels of the feature and contour sections is calculated by the edge enhancement formula shown in [Formula 2] mentioned above on the basis of the sample image smoothed in the previous smoothing step (step S6), and the calculated difference is obtained as basic data for a focus evaluated value.

Then, the luminance standardization step (step S8) of standardizing the focus evaluated value calculated in step S7 with the screen average luminance is performed. This step is executed by the evaluated value calculation circuit 11C. In the example shown in FIG. 3, the focus evaluated value Pv(i) based on standardized luminance in [Formula 3] is calculated by dividing the focus evaluated value (Pvo(i)) obtained by the previous edge enhancement step (step S7) by the screen average luminance (Pave(i)) obtained in the screen average luminance calculating step (step S5).

The above-mentioned steps S2 to S8 constitute an autofocus loop (AF loop). In the AF loop, a process similar to the above-mentioned one is executed on a sample image acquired at each focused position.

In the present embodiment, as mentioned above, the CCD camera 6 captures images of the subject sample W at a predetermined sampling period with the objective lens 3 being continuously driven by the lens driving section 4, and the image acquiring step (step S3) and the focus evaluated value calculating step (step S8) are processed in parallel (FIGS. 6 and 7). Accordingly, while the focus evaluated value of the previously acquired sample image is being calculated, the next sample image can be acquired, so that a focus evaluated value can be calculated at a period of one frame of video signals and an increase in the speed of autofocus operation can be realized.

When the total movement length of the objective lens 3 reaches a full search range, the AF loop is brought to an end and the process of multiplying the focus evaluated value of each of the acquired sample images by the maximum value (Pavemax) of screen average luminance is executed (steps S9 and S10). In consequence, the focus evaluated value Pv of each of the sample images becomes equivalent to the case found by the operating formula shown in [Formula 4] mentioned above.

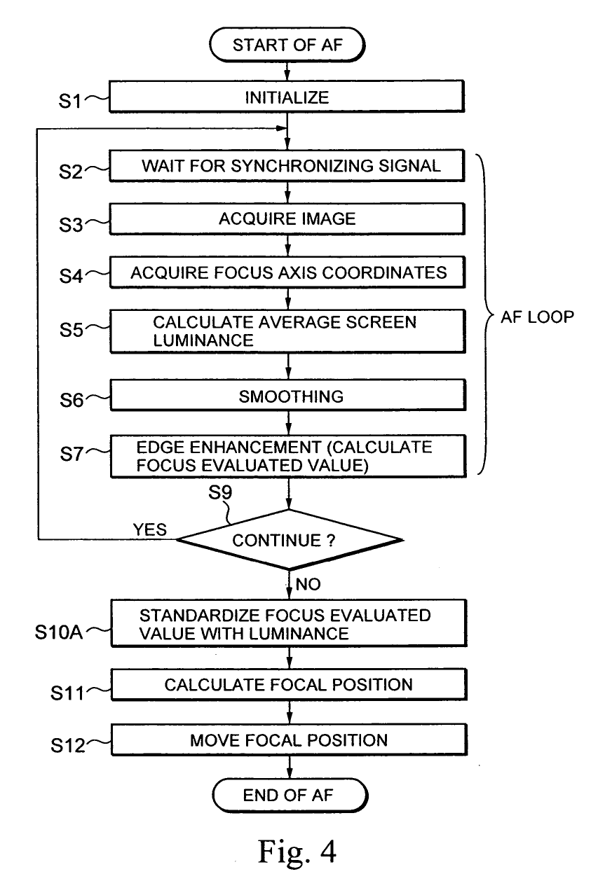

It is noted that, as in the flowchart shown in FIG. 4, the AF loop may be completed after the calculation of the focus evaluated value in the edge enhancement and, as shown in step S10A in FIG. 4, after the completion of the AF loop, the standardization of the focus evaluated value with the screen average luminance may be collectively performed on all sample images by using the operating process shown in [Formula 4]. In this case as well, as a consequence, it is possible to realize a process similar to the example shown in FIG. 3.

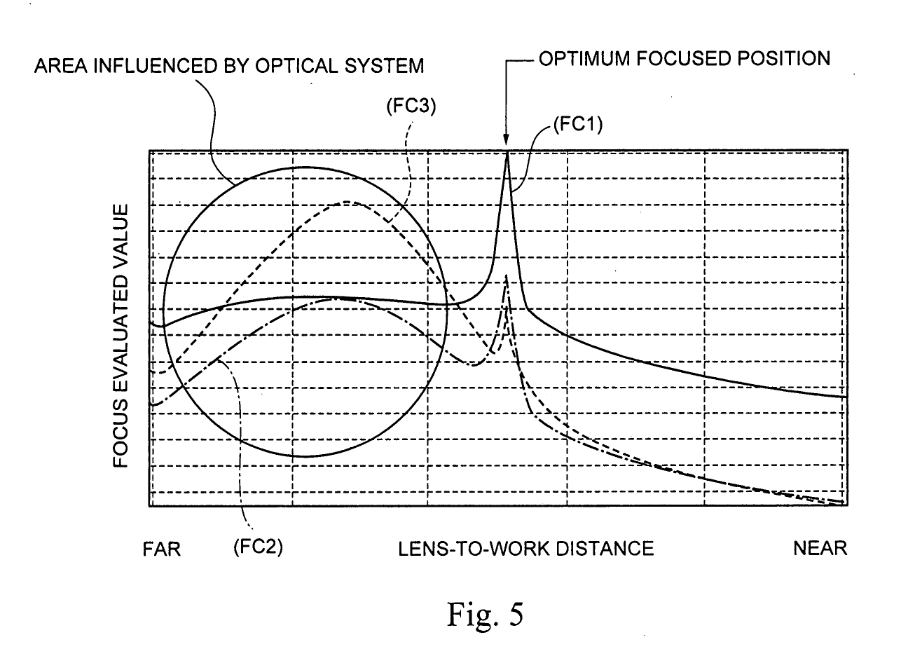

In FIG. 5, a solid line shows a focus curve (FC1) obtained by performing smoothing (step S6 in FIG. 3) and luminance standardization (step S8 in FIG. 3), and a dot-dashed line shows a focus curve (FC2) obtained by performing only smoothing without performing standardization using screen average luminance. For comparative purposes, a conventional focus curve (FC3) shown in FIG. 22 is shown by a dotted line.

As can be seen from FIG. 5, according to the present embodiment, it is possible to greatly ameliorate an area influenced by an optical system and make apparent a peak of a focus evaluated value to be detected as an optimum focused position (focal position). Accordingly, it is possible to realize stable and accurate autofocus operation even in short-wavelength and single-wavelength optical systems.

In addition, since the area influenced by the optical system can be ameliorated only by smoothing of a sample image, the luminance standardization step (step S3 in FIG. 3) may be omitted if necessary. However, by performing the luminance standardization step, it is possible to achieve further amelioration of the area influenced by the optical system, so that it is possible to achieve far more accurate detection of the focused position.

Then, a focal position calculating step (step S11) is performed. This focal position calculation process is executed by the focal position calculation circuit 11D. In calculation of a focused position, as mentioned with reference to FIG. 6, approximate curves passing through points including the maximum value of the focus evaluated value and a plurality of neighboring focus evaluated values are found to detect an apex, and the apex is determined as the focused position.

Accordingly, the focal position can be efficiently and highly accurately detected compared to hill-climbing methods which have heretofore been widely used, so that it is possible to greatly increase the speed of autofocus operation.

On the other hand, in the case where the lens-to-work distance along the horizontal axis of FIG. 6 is set to the full search range, if it can be determined that the objective lens 3 has passed through a focused position during operation, image acquisition becomes unnecessary at any point subsequent to Pv(m+3), so that operation time can be reduced by that amount. As a technique for determining whether an objective lens has passed through a focal position, there is a method of acquiring the number of samples necessary for approximation by causing an objective lens to pass through a hill exceeding a certain focus evaluated value (which is given as a parameter or is learned from the result of past focus operation) and the like.

Finally, the step of causing the objective lens 3 to move to the focal position (step S12) is performed, and the autofocus control of the present embodiment is completed.

As mentioned above, according to the present embodiment, it is possible to stably perform highly accurate autofocus control by eliminating influences due to short-wavelength and single-wavelength optical systems, so that, for example, microstructures formed on a surface of a semiconductor wafer can be observed and inspected with high resolution.

### SECOND EMBODIMENT

A second embodiment of the present invention will be described below.

As the miniaturization of minimum pattern widths (process rules) proceeds, recent semiconductor wafers are beginning to assume more three-dimensional structures in their height directions. Light sources having shorter wavelengths need shallower depth of focus and have a disadvantageous tendency to decrease the number of focusable sections of an object having a great difference of height. If a difference of height exits in a screen and different surfaces are focusable at different heights, it is necessary to perform an active focusing operation which can determine “where to be focused on”, for example, which of the surfaces of a sample is to be used as a reference surface. However, a conventional autofocus control method of finding an optimum focused position from focus evaluated values has the disadvantage of being unable to bring a desired section into focus.

To cope with this problem, a method of applying an autofocus control method according to the present invention and bringing into focus an arbitrary surface of a sample allowing a difference of height to exist in a screen will be described below.

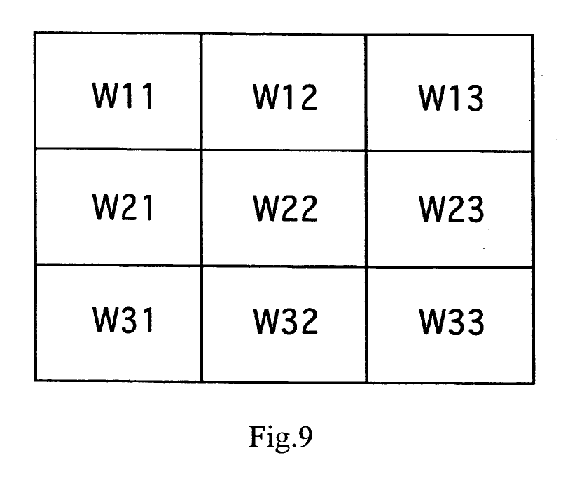

In the above description of the first embodiment, reference has been made to an example in which a focus evaluated value is calculated on the whole (or a partial area) of an acquired sample image. In the present embodiment, as shown in FIG. 9 by way of example, an acquired sample image is divided into a plurality of areas, and focus evaluated values are calculated to calculate focal positions for the respective divided areas Wij(i, j=1 to 3).

In the calculation of the focus evaluated value of each of the divided areas Wij, image smoothing and standardization using screen average luminance which are similar to those of the above-mentioned first embodiment are executed. Accordingly, the focal positions can be highly accurately detected without being influenced by an optical system.

Through the above-mentioned process, focus curves corresponding to the respective divided areas Wij are obtained. At this time, in a case where one of the divided areas differs in focal position from another, it becomes apparent that a difference of height in the focal plane exists between both areas, so that it becomes possible to perform an active focusing operation by designating with a parameter what is to be given priority in determining a focused position.

Examples of the parameter are as follows.

1. A target at the shortest lens-to-sample distance (the highest location of a sample).

2. A target at the longest lens-to-sample distance (the lowest location of a sample).

3. A particular position in a screen.

4. An optimum focused position decided by majority from the result of screen division (a more characteristic section).

In addition, although the example in which the number of screen division is 3×3, i.e., 9, has been mentioned with reference to FIG. 9, the number of screen division is not limitative. As the number of screen division is increased, more detailed information can be obtained. In addition, divided screens may overlap one another, and the number of screen division may be dynamically changed according to use conditions.

As mentioned above, according to the present embodiment, it is possible to satisfactorily cope with an active focusing operation which can determine “where to be focused on”, by designating what is to be given priority in determining a focused position for a target sample.

### THIRD EMBODIMENT

A third embodiment of the present invention will be described below. In the description of the present embodiment, reference will be made to a method of synthesizing an omnifocal image of a subject sample from acquired image data by applying an autofocus control method according to the present invention.

In the case of a normal optical system, if a three-dimensional object exceeding the depth of focus of the optical system is viewed therethrough, a globally focused image cannot be viewed, so that the purpose of inspection or observation cannot be satisfied. Attempts to solve this problem are made by using a method of obtaining a globally focused omnifocal image by using a special optical system such as a confocal optical system and a method of obtaining a globally focused image from images of different angles on the basis of trigonometry, but neither of these methods can be inexpensively realized, because special optical systems need to be employed.

On the other hand, a method of performing synthesis on images of an object after having hierarchically acquired the images has been proposed (Japanese Patent Application Laid-Open No. 2003-281501). However, there remain problems such as the capacity of image information to be used for synthesis, synthesis processing time, and a result only obtainable after the acquisition of a plurality of images.

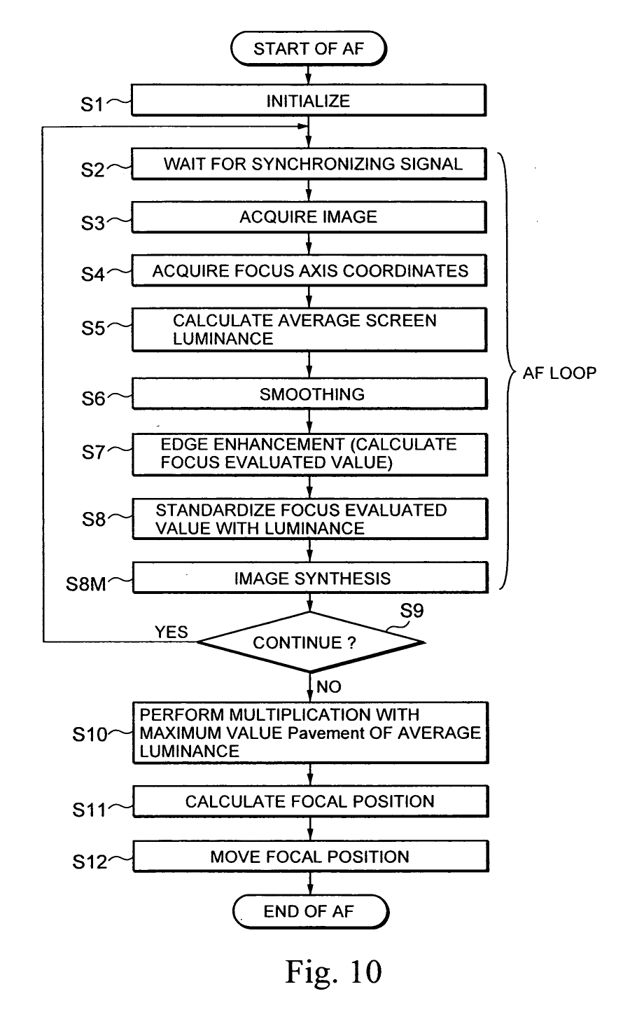

To cope with these problems, in the present embodiment, an omnifocal image of the subject sample W is obtained in the process of executing the autofocus control method mentioned above in the description of the first embodiment. The control flow is shown in FIG. 10. An image synthesizing step (step S8M) is added after the step (step 8) of standardizing the focus evaluated value of an acquired image (sample point) with the corresponding screen average luminance.

The other steps are similar to the corresponding steps of the process flow (FIG. 3) mentioned above in the description of the first embodiment, and the corresponding steps are denoted by identical reference numerals and the description thereof is omitted.

In image synthesis, as mentioned above in the description of the second embodiment, an acquired sample image is divided into a plurality of areas (FIG. 9), and images corresponding to the respective divided areas Wij are synthesized. It is noted that the number of screen division is not particularly limitative, and as the number of screen division is increase, finer processing can be performed. The size of each divided area can be scaled to the unit of one pixel. In addition, the shape of each divided area is not limited to a square, and can also be modified into a circle or the like.

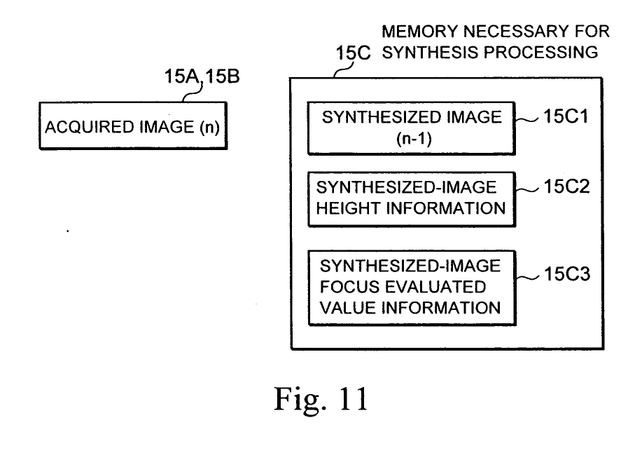

As the memory 15 (FIG. 2), as shown in FIG. 11, a third memory section 15C for omnifocal processing is prepared in addition to the second memory section 15A which processes image data loaded during even frames and the second memory section 15B which processes image loaded during odd frames. The third memory section 15C is provided with a synthesized image data storage area 15C1, a storage area 15C2 for storing height (lens-to-work distance) information on each of the divided areas Wij constituting a synthesized image, and a storage area 15C3 for storing focus evaluated value information on each of the divided areas Wij.

In the synthesis of an omnifocal image of a subject sample, sample images are acquired at a plurality of focused positions differing from one another in lens-to-work distance, and focus evaluated values for the respective divided areas Wij are calculated on each of the sample images, and after an image has been extracted which is relatively independent and shows the highest focus evaluated value among the divided areas Wij, the processing of synthesizing an entire image is performed.

“Omnifocal image synthesizing means” in the present invention is constructed in the above-mentioned manner. Referring to the process flowchart shown in FIG. 10, the process of steps S1 to S8 is executed on an acquired sample image in units of each divided areas Wij by a technique similar to that used. in the above-mentioned first embodiment, and then, the process goes to the image synthesizing step of step S8M.

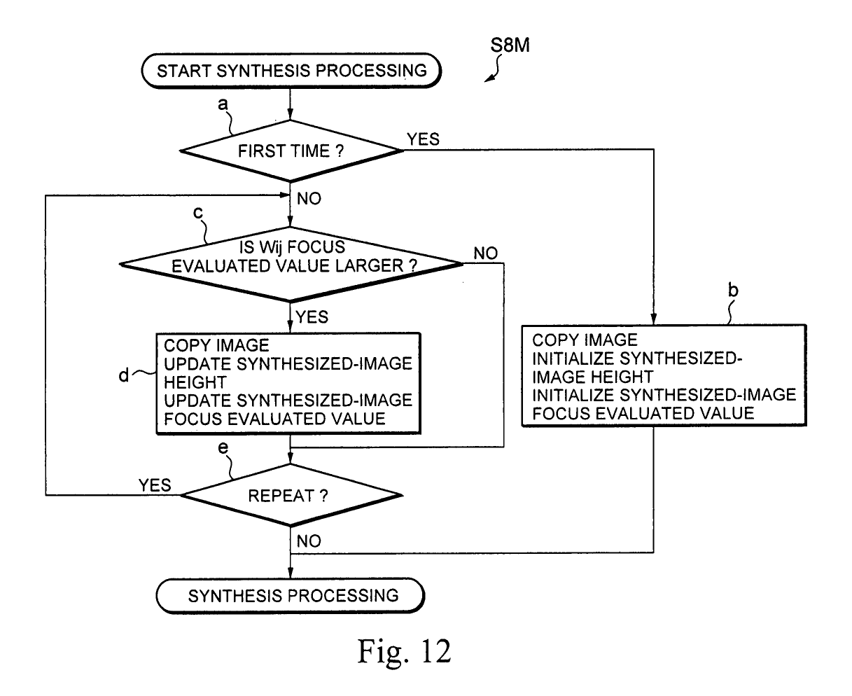

FIG. 12 shows details of step S8M. After the start of an autofocus operation, the first acquired image is used to initialize the third memory section 15C (steps a and b). Namely, in step b, the first image is copied to the synthesized image data storage area 15C1 and the height information storage area 15C2 is filled with the first data, and focus evaluated values are copied to the storage area 15C3 for storing focus evaluated value information for the divided areas Wij, thereby initializing the third memory section 15C.

In each of the second and subsequent processings, the focus evaluated value of an acquired image and the focus evaluated value of a synthesized image are compared with each other for each of the divided areas Wij (step c). In a case where the focus evaluated value of the acquired image is larger, the image is copied, and height information and focus evaluated value information corresponding to the copied image are updated (step d). Conversely, in a case where the focus evaluated value of the acquired image is smaller, no updating is performed. This operation is repeated by the number of screen division (step e). In this manner, a process for one frame (33.3 msec) is completed.

In the operation flow of the autofocus control sequence, for example, while the image data of an even frame is being loaded into the second memory section 15A, the above-mentioned process is performed on each of the divided areas Wij of the image data of the previous odd frame which is already loaded in the second memory section 15B, and the necessary data and information are copied or updated in the corresponding storage area of the third memory section 15C.

In the present embodiment, the above-mentioned process is performed together with the autofocus control of the subject sample W mentioned above in the description of the first embodiment, but the process can also be independently performed.

The above-mentioned process is performed on the number of images necessary for autofocus, so that a best-focus section, height information on the section, and a focus evaluated value thereof can be obtained for each of the divided areas Wij at the time of completion of autofocus operation. Accordingly, not only the focused position coordinates of the subject sample W but also an omnifocal image and the shape of the subject sample W can be acquired online and in real time for each of the divided areas Wij.

In particular, if the synthesized image copied to the synthesized image data storage area 15C1 is displayed on the monitor 9 (FIG. 1), the manner of focusing in each of the divided areas can be observed during the process of movement of the objective lens 3 over the full search range, so that the state of height distribution of the displayed subject sample W can be easily grasped during autofocus operation.

Furthermore, since the omnifocal image of the subject sample is synthesized by using the autofocus control method according to the present invention, it is possible to ensure highly accurate autofocus control by eliminating influences due to short-wavelength and single-wavelength optical systems, so that an omnifocal image of surfaces of a hierarchically developed structure such as a semiconductor wafer can be acquired with high resolution.

### FOURTH EMBODIMENT

A method of synthesizing a three-dimensional image of a subject sample from image data acquired during autofocus operation will be described below as a fourth embodiment of the present invention.

As mentioned above, the image autofocus operation acquires sample images at a plurality of focused positions and performs focus evaluation. Accordingly, in the present embodiment, it is possible to synthesize a three-dimensional image by extracting focused sections from acquired sample images and combining the focused sections with information associated with the height direction.

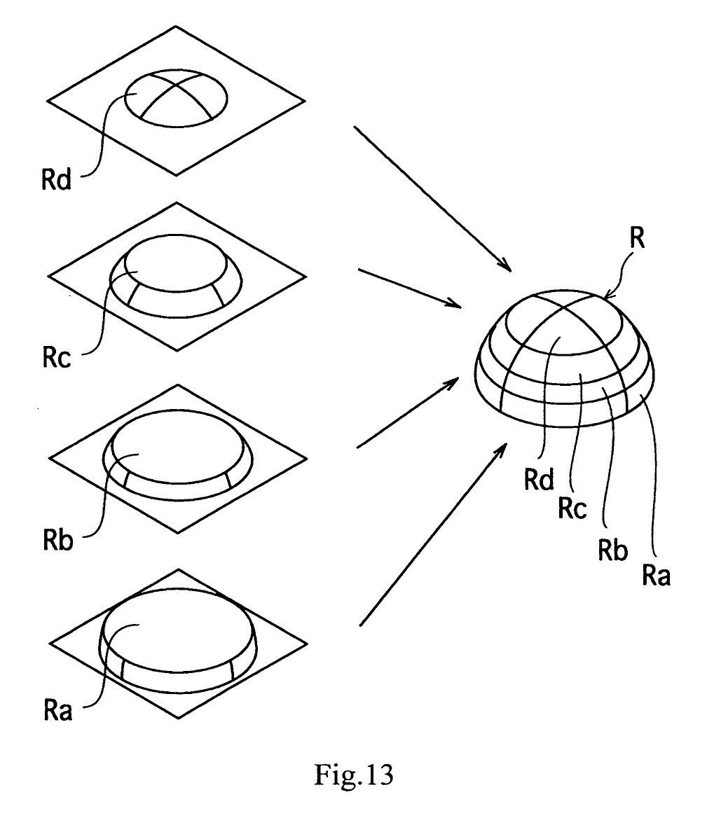

As shown in FIG. 13 by way of example, after focused position detection has been performed on each of sample images Ra, Rb, Rc and Rd acquired during an autofocus operation, focused sections are extracted and are combined with one another in the height direction (in the focus-axis direction), so that a three-dimensional image of a structure R can be synthesized.

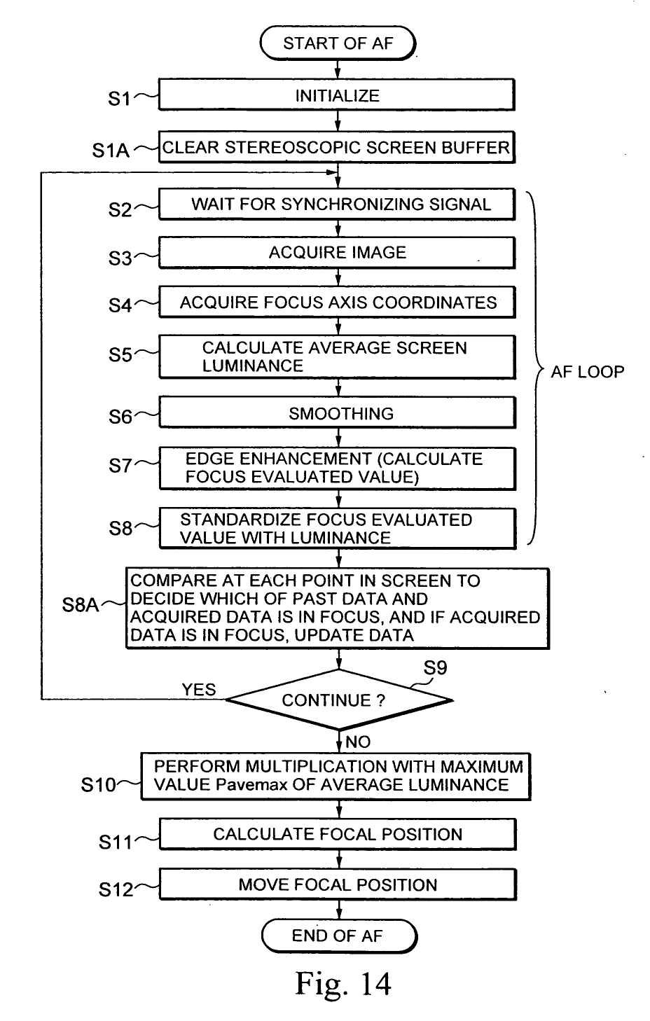

One example of the method of synthesizing a three-dimensional image according to the present embodiment is shown in the flowchart of FIG. 14. In FIG. 14, steps corresponding to those of the above-mentioned first embodiment (FIG. 3) are denoted by identical reference numerals and the description thereof is omitted.

In the present embodiment, a three-dimensional image buffer clearing step (step S1A) is provided after the initializing step (step S1). In step S1A, initialization is performed on a memory area which stores the past acquired three-dimensional image. Then, as in the case of the above-mentioned first embodiment, sample images of a subject sample are acquired at a plurality of focused positions, and smoothing, calculation of a focus evaluated value through edge enhancement, and standardization of the calculated focus evaluated value with the corresponding screen average luminance are performed on each of the sample images (steps S2 to S8).

After the calculation of the focus evaluated values, the past data and the acquired data are compared at each point in the screen to decide which of the past data and the acquired data is in focus, and if the acquired data is in focus, the process of updating the data is performed (step S8A) . This process is executed on each of the sample images.

“Three-dimensional image synthesizing means” in the present invention is constructed in the above-mentioned manner. It is noted that, in the present embodiment, the screen is divided into a plurality of areas Wij as in the case of the above-mentioned second embodiment so that the above-mentioned process is performed on each of the divided areas, but the number of screen division is not particularly limitative and the process may also be performed in a unit of pixel.

Therefore, according to the present embodiment, it is possible to easily acquire not only optimum focused position information on the subject sample W but also a three-dimensional image of surfaces of the subject sample by combining a plurality of focused sample images with one another in the height direction after the completion of autofocus control.

Furthermore, since a three-dimensional image of a subject sample is synthesized by using the autofocus control method according to the present invention, it is possible to ensure highly accurate autofocus control by eliminating influences due to short-wavelength and single-wavelength optical systems, so that a three-dimensional image of surfaces of a hierarchically developed structure such as a semiconductor wafer can be acquired with high resolution.

### FIFTH EMBODIMENT

A fifth embodiment of the present invention will be described below.

In the above description of each of the embodiments, reference has been made to the example in which the autofocus control method according to the present invention is realized by the image processing apparatus 1 which uses a computer as the core. This construction is more or less complicated and may not match needs for simple focusing. Namely, if an algorithm which executes the autofocus control method according to the present invention by simple hardware can be realized for various cases which do not need post-focusing processing, the present invention can be used in a far wider range of applications and can be considered to greatly contribute to industrial automation.

Accordingly, in the description of the present embodiment, reference is made to the construction of an autofocus control apparatus capable of realizing the above-mentioned autofocus control method according to the present invention without using a computer. As will be mentioned later, the autofocus control apparatus can be constructed with a video signal decoder, an arithmetic element represented by an FPGA (Field Programmable Gate Array), a setting storing memory and the like, and, if necessary, further employs integrated circuits such as a CPU (Central Processing Unit), a PMC (Pulse Motor Controller) and an external memory. These elements are mounted on a common wiring board and are used as a single circuit board unit or a package component which contains the circuit board unit.

### FIRST CONSTRUCTION EXAMPLE

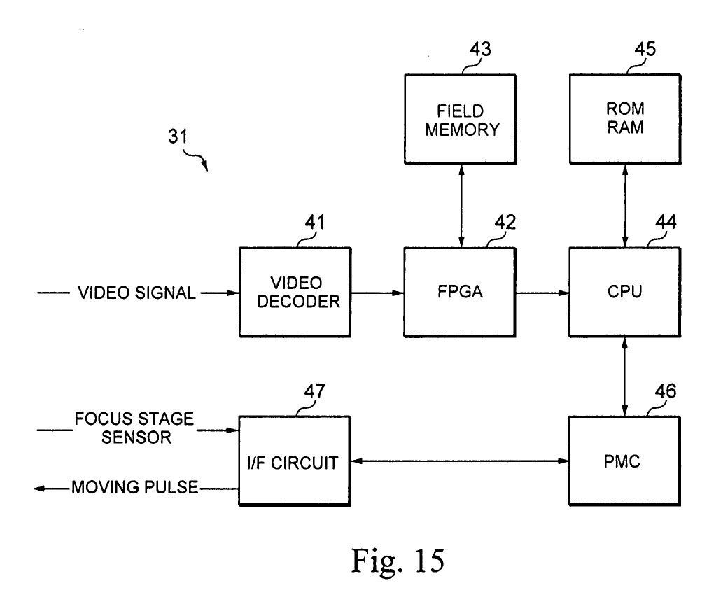

FIG. 15 shows a functional block diagram of a first construction example of the autofocus control apparatus according to the present invention. The shown autofocus control apparatus 31 is constructed with a video signal decoder 41, an FPGA 42, a field memory 43, a CPU 44, a ROM/RAM 45, a PMC 46, and an I/F circuit 47.

A video signal to be used for autofocus operation is an analog image signal encoded in NTSC format, and the analog image signal is converted by the video signal decoder 41 into a digital image signal which includes horizontal/vertical synchronizing signals, EVEN (even-numbered)/ODD (odd-numbered) field information, and luminance information.

The FPGA 42 is constructed with arithmetic elements for performing predetermined computational processes in the autofocus control flow (FIG. 3) according to the present invention which have been mentioned above in the description of the first embodiment, and corresponds to the “image smoothing means”, the “edge enhancement means” and the “evaluated value calculating means” in the present invention.

The FPGA 42 extracts information on an effective section in a screen from the synchronizing signals and the field information digitized by the video signal decoder 41, and stores luminance information on the effective section into the field memory 43. At the same time, data are sequentially read from the field memory 43, and are subjected to computational processes such as filtering (image smoothing), average luminance calculation and focus evaluated value calculation. In addition, the functions of the field memory 43, the CPU 44 and the PMC 46 can also be incorporated in the FPGA 42 according to the degree of integration of the FPGA 42.

The field memory 43 is used for temporarily storing the field information in order to handle a video signal which is outputted in interlaced form and includes frames each of which is made of an even field and an odd field.

The CPU 44 manages the operation of the entire system, for example, varies the lens-to-work distance by causing the PCM 46 and the I/F circuit 47 to move a stage supporting a subject sample and calculates an optimum focused position (focal position) from the focus evaluated values of sample images respectively acquired at focused positions and computed by the FPGA 42. In this example, the CPU 44 corresponds to the “focal position calculating means” in the present invention.

The ROM/RAM 45 is used for storing operation software for the CPU 44 (programs) and the parameters necessary for calculation of focal positions. The ROM/RAM 45 may also be contained in the CPU.

The PMC 46 is a control device for driving a pulse motor (not shown) which moves the stage, and controls the stage via the interface (I/F) circuit 47. In addition, the output of a sensor which detects the position of the stage is supplied to the PCM 46 through the I/F circuit 47.

In the autofocus control apparatus 31 constructed in the above-mentioned manner, a video signal of a sample image is supplied from a CCD camera which is not shown. This video signal is inputted to the FPGA 42 via the video signal decoder 41, in which smoothing, average luminance calculation and focus evaluated value computation are performed on the input image. The FPGA 42 transfers focus evaluated data to the CPU 44 at the timing of a synchronizing signal indicative of the end of a field.

The CPU 44 acquires the coordinates of a focus stage at the timing of the end of the field, and uses the coordinates as the lens-to-work distance. After the above-mentioned process has been repeated by the number of times necessary for the autofocus operation of the present invention, the CPU 44 performs calculations of focused positions. Then, the CPU 44 causes the stage to move to an optimum focused position, and completes the autofocus operation. In addition, a screen division function, omnifocal image synthesis for the subject sample, and/or three-dimensional image synthesis are performed if necessary.

If the autofocus control apparatus of the present invention constructed in the above-mentioned manner is organically connected to existing focus axis moving means such as CCD cameras, monitors and pulse motors, it is possible to realize a function equivalent to the above-mentioned image processing apparatus 1, so that it is possible to carry out the autofocus control method according to the present invention by means of an easy and simple construction. Accordingly, the autofocus control apparatus of the present invention is also extremely advantageous in terms of cost and installation space.

### SECOND CONSTRUCTION EXAMPLE

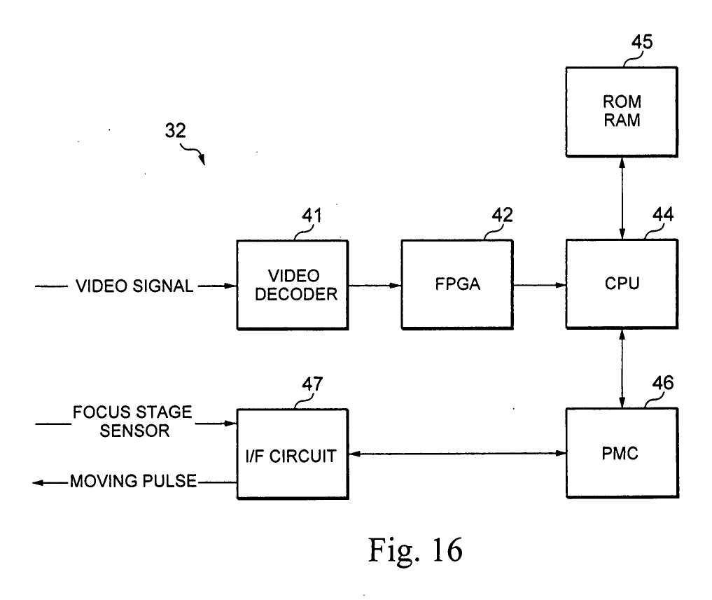

FIG. 16 is a functional block diagram of a second construction example of the autofocus control apparatus according to the present invention. Sections corresponding to those used in the first construction example (FIG. 15) are denoted by identical reference numerals, and the detailed description thereof is omitted. In the present construction example, an autofocus control apparatus 32 is constructed with the video signal decoder 41, the FPGA 42, the CPU 44, the ROM/RAM 45, the PMC 46 and the I/F circuit 47.

The above-mentioned autofocus control apparatus 31 of the first construction example is adapted to use the field memory 43 and perform control with frame information in order to process an interlaced image as an image similar to a TV (television) image. However, if only autofocus operation is taken into account, frame information need not be used, and there is also a case where the required process needs only to be performed in units of fields. In addition, this fact may provide merit.

For this reason, the autofocus control apparatus 32 according to the present embodiment has a construction in which the field memory 43 is removed from the first construction example. According to this construction, timing processing for transfer of information to the field memory is not necessary, so that a physically and logically simple construction can be achieved compared to the above-mentioned first construction example. In addition, since focus evaluation processing can be performed in units of fields, various other merits can be provided, for example, the interval of sampling of focus evaluated values can be reduced compared to the first construction example which performs processing in units of frames.

### THIRD CONSTRUCTION EXAMPLE

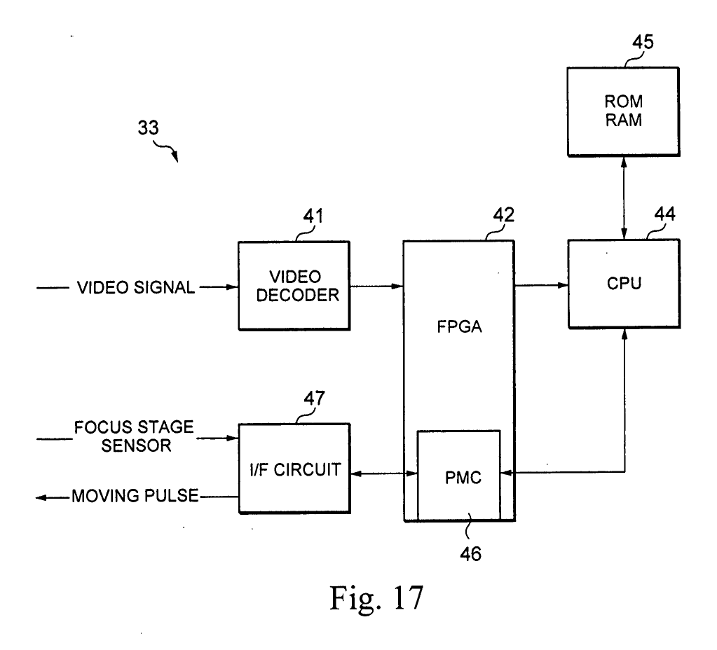

FIG. 17 is a functional block diagram of a third construction example of the autofocus control apparatus according to the present embodiment. Sections corresponding to those used in the first construction example (FIG. 15) are denoted by identical reference numerals, and the detailed description thereof is omitted. In the present construction example, an autofocus control apparatus 33 is constructed with the video signal decoder 41, the FPGA 42, the CPU 44, the ROM/RAM 45, the PMC 46 and the I/F circuit 47.

The autofocus control apparatus 33 of the present construction example is equipped with a construction in which the logical block of the PMC 46 is contained in the FPGA 42 and an independent logic circuit of the PMC 46 is unnecessary compared to the above-mentioned construction example. According to this construction, an independent IC chip for the PMC 46 is unnecessary, so that reductions in circuit board size and mounting cost can be realized.

### FOURTH CONSTRUCTION EXAMPLE

FIG. 18 is a functional block diagram of a fourth construction example of the autofocus control apparatus according to the present embodiment. Sections corresponding to those used in the first construction example (FIG. 15) are denoted by identical reference numerals, and the detailed description thereof is omitted. In the present construction example, an autofocus control apparatus 34 is constructed with the video signal decoder 41, the FPGA 42, the CPU 44, the ROM/RAM 45, an AD (Analog to Digital)/DA (Digital to Analog) circuit 48, and the I/F circuit 47.

The autofocus control apparatus 34 of the present construction example is an example in which a driving source for the focus stage is constructed with an analog-signal-controlled piezoelectric stage instead of a pulse motor, and the AD/DA circuit 48 is used in place of the PMC 46 in the above-mentioned second construction example. In addition, the AD/DA circuit 48 can be incorporated in, for example, the CPU 44, and in this case the AD/DA circuit 48 need not be provided as an external circuit.

In the AD/DA circuit 48, a DA circuit section is a circuit for converting a directed voltage from the CPU 44 into an analog signal, while an AD circuit section is a circuit for converting a signal from a sensor (not shown) which detects the movement position of the piezoelectric stage, into a digital signal and feeding back the digital signal to the CPU 44. If such feedback control need not be performed, the AD circuit section may be omitted.

### FIFTH CONSTRUCTION EXAMPLE

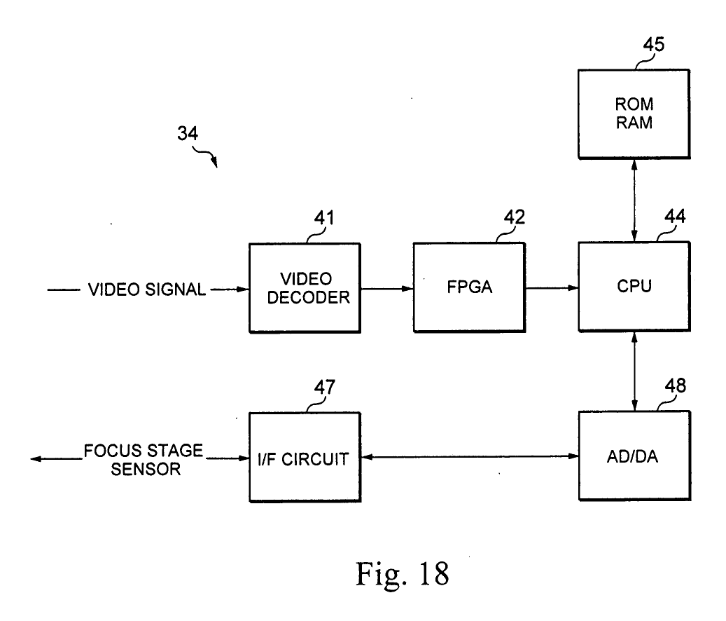

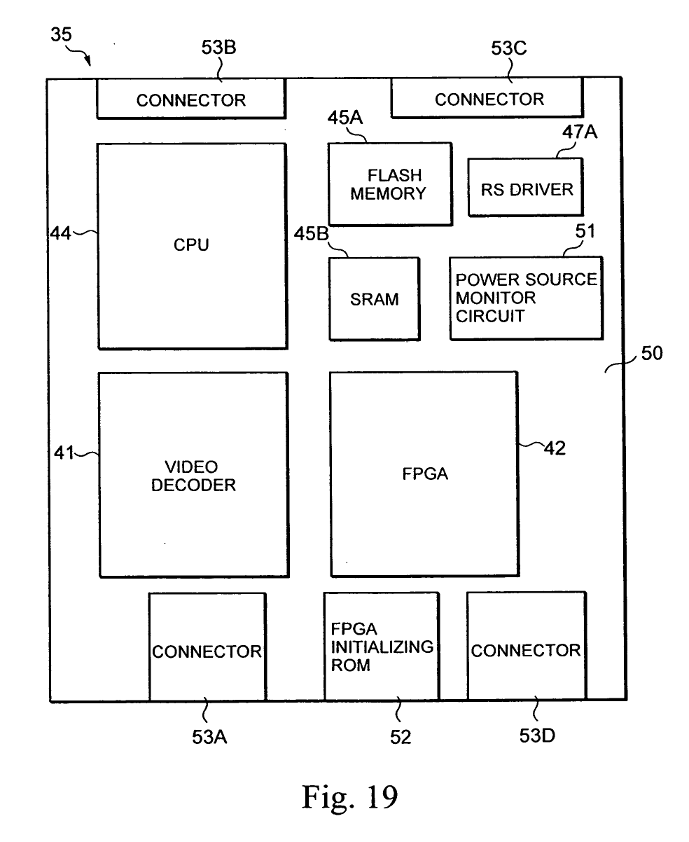

FIG. 19 shows, as a fifth construction example of the present embodiment, a specific construction example of the autofocus control apparatus 33 which constitutes the above-mentioned third construction example (FIG. 17). Sections corresponding to those shown in FIG. 17 are denoted by identical reference numerals, and the detailed description thereof is omitted.

In the present construction example, an autofocus control apparatus 35 is constructed with the video signal decoder 41, the FPGA 42, the CPU 44, a flash memory 45A, an SRAM (Static Random Access Memory) 45B, an RS driver 47A, a power source monitor circuit 51, an FPGA initializing ROM 52, and a plurality of connectors 53A, 53B, 53C and 53D, all of which are mounted on a common wiring board 50.

The flash memory 45A and the SRAM 45B correspond to the above-mentioned ROM/RAM 45, and the flash memory 45A stores operation problems for the CPU 44 and autofocus-operation initializing information (such as a focus movement speed and a smoothing condition), while the SRAM 45B is used for temporarily storing the various parameters necessary for computations of focused positions in the CPU 44.

The RS driver 47A is an interface circuit which is necessary for communications with external equipment connected via the connectors 53A to 53D. In this example, a CCD camera is connected to the connector 53A, and a higher-level controller or CPU is connected to the connector 53B. A power source circuit is connected to the connector 53C, and a focus stage is connected to the connector 53D. The focus stage is equipped with a pulse motor as a driving source, and a PMC serving as a controller for the pulse motor is incorporated in the FPGA 42.

As mentioned above, the autofocus control apparatus 35 according to the present construction example can be constructed as a board-mounted structure having, for example, a square external shape 100 mm on a side, in which various devices capable of executing an algorithm to realize the autofocus control method according to the present invention are mounted on the single wiring board 50. This construction makes it possible to realize reductions in apparatus costs and simplification of apparatus constructions. In addition, since the freedom of installation of equipment can be increased, it is possible to easily meet on-site needs for autofocus operation in industrial fields where autofocus control equipment would not have been used.

Although the embodiments of the present invention have been described above, the present invention, of course, is not limited to any of the embodiments and can be modified in various ways on the basis of the technical idea of the present invention.

For example, in the above description of the first embodiment, reference has been made to the construction which moves the objective lens 3 in the focus-axis direction in order to vary the lens-to-sample distance. Alternatively, the stage 2 for supporting a sample may be adapted to be moved.

In the above-mentioned first embodiment, a driving system for varying the lens-to-sample distance is constructed with the lens driving section 4 made of a piezoelectric device and the driver 8 thereof. This driving system is not limitative, and it is possible to use various other driving systems capable of highly accurately and smoothly varying the lens-to-sample distance.

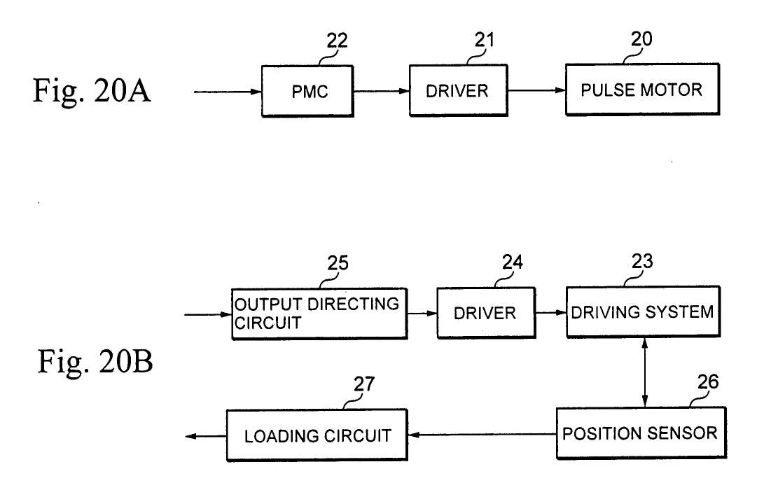

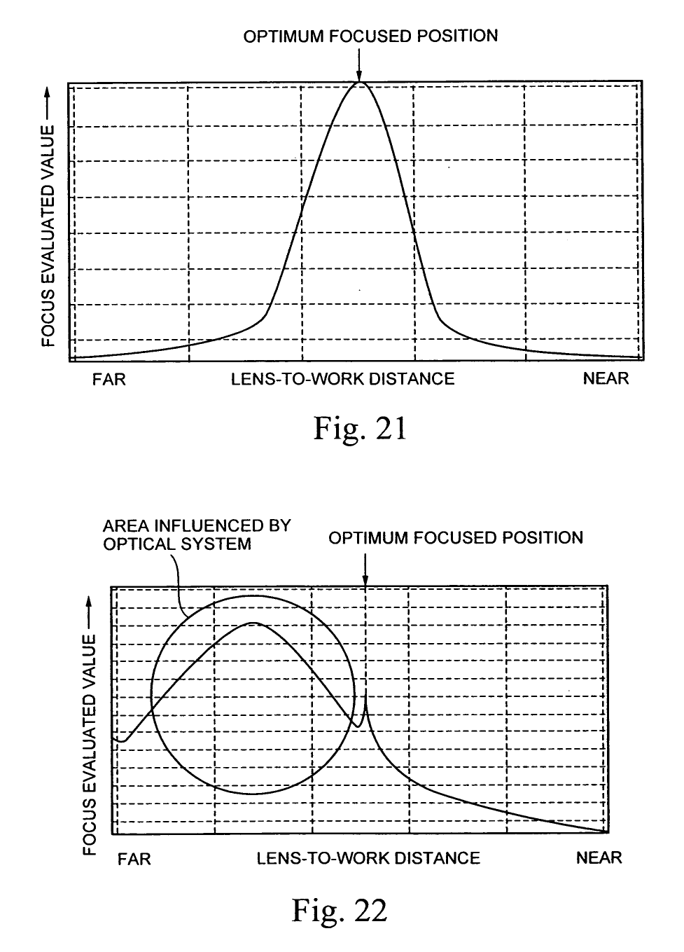

By way of example, FIG. 20A shows an example using a pulse motor 20 as a driving source. In this case, a driver 21 generates a driving signal for the pulse motor 20 on the basis of a control signal supplied from a pulse motor controller 22.

In addition, although the lens driving section 4 and the pulse motor 20 are adapted to be driven by so-called feedfoward control, it is possible to use a construction in which a sensor for detecting lens positions or stage positions is provided for feedback control of a driving source.

FIG. 20B shows one construction example of a driving system which controls a driving source by feedback control. A driver 24 generates a driving signal for a driving system 23 on the basis of a control signal supplied from an output directing circuit 25. In this case, a cylinder unit, a motor or the like can be applied to the driving system 23. A position sensor 26 may be constructed with a strain gauge, a potentiometer or the like, and supplies its output to a loading circuit 27. The loading circuit 27 supplies a position compensation signal to the output directing circuit 25 on the basis of the output of the position sensor 26 to perform position correction of the driving system 23.

In the above description of each of the embodiments, reference has been made to the example where the video signals supplied from the CCD camera are in NTSC format, but video signals can also be processed by the PAL (Phase Alternation by Line) format. Video signal decoder sections can also be replaced to cope with other formats such as IEEE 1394 and Camera Link. In this case, the function of a video signal decoder circuit may also be incorporated in the FPGA 42.

Furthermore, the focus evaluated values and the focused positions of sample images obtained by executing the autofocus control according to the present invention can also be displayed on the monitor 9 (FIG. 1) together with the sample images. In this case, an encoder circuit for converting such information to NTSC or the like and displaying an NTSC image may be separately provided. This encoder circuit may also be formed as one of the board-mounted components of, for example, the autofocus control apparatus having the construction mentioned above in the description of the fifth embodiment.

1-34. (canceled)

35. An autofocus control method including:
an image acquiring step of acquiring respective image data of a subject at a plurality of focused positions differing from one another in a distance between a lens and the subject;
an evaluated value calculating step of calculating a focus evaluated value for each of said plurality of focused positions on the basis of said respective acquired image data;
a focal position calculating step of calculating a focused position where said focus evaluated value reaches a maximum, as a focal position; and
a moving step of relatively moving said lens to said calculated focal position with respect to said subject,
autofocus control method characterized by including:
an image smoothing step of smoothing said acquired image data; and
an average luminance calculating step of calculating screen average luminance of said acquired image data, and in that:
said focus evaluated value is a value obtained by dividing the focus evaluated value calculated on the basis of said smoothed image data by said calculated screen average luminance.

36. An autofocus control method according to claim 35, characterized in that, in said evaluated value calculating step, said focus evaluated value is calculated on the basis of a luminance data difference between adjacent pixels in said acquired image data.

37. An autofocus control method according to claim 35, characterized in that, in said focal position calculating step, said focal position is calculated on the basis of a maximum of said calculated focus evaluated value and a plurality of neighboring focus evaluated values.

38. An autofocus control method according to claim 35, characterized in that, in said image acquiring step, said respective image data is acquired at said plurality of focused positions while said distance between the lens and the subject is continuously varied.

39. An autofocus control method according to claim 35, characterized in that said image acquiring step and said evaluated value calculating step are performed in parallel.

40. An autofocus control method according to claim 35, characterized in that ultraviolet light is used as a light source for illuminating said subject.

41. An autofocus control method according to claim 35, characterized by dividing said acquired image data into a plurality of areas and calculating said focal position for each of said divided areas.

42. An autofocus control method according to claim 41, characterized by acquiring an omnifocal image of said subject by synthesizing images at said focal positions of said respective divided areas among said divided areas.

43. An autofocus control method according to claim 41, characterized by acquiring a three-dimensional image of said subject by synthesizing images at said focal positions of said respective divided areas among said plurality of focused positions.

44. An autofocus control apparatus including:
evaluated value calculating means which calculates a focus evaluated value for a plurality of focused positions on the basis of respective acquired image data acquired at said plurality of focused positions differing from one another in a distance between a lens and a subject; and
focal position calculating means which calculates a focal position on the basis of a maximum of said calculated focus evaluated value,
said autofocus control apparatus characterized by including:
image smoothing means which smoothes said acquired image data; and
average luminance calculating means which calculates screen average luminance of said acquired image data, and
characterized in that said focus evaluated value is a value obtained by dividing the focus evaluated value calculated on the basis of said smoothed image data by said calculated screen average luminance.

45. An autofocus control apparatus according to claim 44, characterized in that said evaluated value calculating means is edge enhancement means which calculates a luminance data difference between adjacent pixels in said acquired image data.

46. An autofocus control apparatus according to claim 44, characterized in that said focal position calculating means calculates said focal position on the basis of a maximum of said calculated focus evaluated value and a plurality of neighboring focus evaluated values.

47. An autofocus control apparatus according to claim 44, characterized by including omnifocal image synthesizing means which synthesizes an omnifocal image of said subject by using said acquired image data.

48. An autofocus control apparatus according to claim 44, characterized by including three-dimensional image synthesizing means which synthesizes a three-dimensional image of said subject by using said acquired image data.

49. An autofocus control apparatus according to claim 44, characterized by being constructed with a board-mounted structure in which said evaluated value calculating means, said focal position calculating means, said image smoothing means, and average luminance calculating means which calculates screen average luminance of said image data are mounted on one circuit board as a single or a plurality of devices.

50. An autofocus control apparatus according to claim 49, characterized in that a driving controlling device for controlling driving means which adjusts said distance between the lens and the subject is mounted on said circuit board.

51. An autofocus control apparatus according to claim 49, characterized in that said evaluated value calculating means, said image smoothing means, and said average luminance calculating means are constructed with a single FPGA (Field Programmable Gate Array).

52. An image processing apparatus including: image acquiring means which acquires respective image data of a subject at a plurality of focused positions differing from one another in a distance between a lens and the subject; evaluated value calculating means which calculates a focus evaluated value for said plurality of focused positions on the basis of said respective acquired image data; focal position calculating means which calculates a focal position on the basis of a maximum of said calculated focus evaluated values; and moving means which relatively moves said lens to said calculated focal position with respect to said subject,
said image processing apparatus characterized by including:
image smoothing means which smoothes said acquired image data; and
average luminance calculating means which calculates screen average luminance of said acquired image data, and
characterized in that said focus evaluated value is a value obtained by dividing the focus evaluated value calculated on the basis of said smoothed image data by said calculated screen average luminance.

53. An image processing apparatus according to claim 52, characterized in that said evaluated value calculating means is edge enhancement means which calculates a luminance data difference between adjacent pixels in said acquired image data.

54. An image processing apparatus according to claim 52, characterized in that said focal position calculating means calculates said focal position on the basis of a maximum of said calculated focus evaluated value and a plurality of neighboring focus evaluated values.

55. An image processing apparatus according to claim 52, characterized by including omnifocal image synthesizing means which synthesizes an omnifocal image of said subject by using said acquired image data.

56. An image processing apparatus according to claim 52, characterized by including three-dimensional image synthesizing means which synthesizes a three-dimensional image of said subject by using said acquired image data.
